(19) United States
(12) Patent Application Publication
(10) Pub. No.: US 2013/0241466 A1
(43) Pub. Date: Sep. 19, 2013

(54) REGENERATIVE POWER SUPPLY SYSTEM

(71) Applicants: Kenro Mitsuda, Tokyo (JP); Tatsunori Okada, Tokyo (JP); Takuto Yano, Tokyo (JP); Hideki Sugita, Tokyo (JP)

(72) Inventors: Kenro Mitsuda, Tokyo (JP); Tatsunori Okada, Tokyo (JP); Takuto Yano, Tokyo (JP); Hideki Sugita, Tokyo (JP)

(73) Assignee: MITSUBISHI ELECTRIC CORPORATION, Tokyo (JP)

(21) Appl. No.: 13/989,942

(22) PCT Filed: Feb. 8, 2012
(86) PCT No.: PCT/JP12/52869

§ 371 Date: May 28, 2013

(30) Foreign Application Priority Data
Feb. 14, 2011 (JP) 2011-028095

(51) Int. Cl. B60L 11/18

(52) U.S. Cl. CPC B60L 11/1809
USPC 320/103

(57) ABSTRACT

A control device controls, with regard to a regenerative current exceeding a current value set at a power migration start point, a first power storage device to be assigned with a current value set at the power migration start point and a second power storage device to be assigned with the regenerative current exceeding the current value set at the power migration start point. The control device increases a sharing ratio of the first power storage device along a curve with a lapse of time, and performs discharge from the second power storage device to the first power storage device when a charge current is equal to or smaller than the current value set at the power migration start point in a period during which the regenerative current exceeding the current value set at the power migration start point is being charged in the first power storage device.

### TECHNICAL FIELD

The present invention relates to a regenerative power supply system including a high-energy first power storage device and a high-output second power storage device that are connected in parallel, for use in brake regeneration in a vehicle, an electric vehicle, a railroad vehicle, or other types of vehicles and output leveling in solar power generation or the like.

### BACKGROUND ART

In a regenerative power supply system including a high-energy first power storage device and a high-output second power storage device that are connected in parallel, the high-output second power storage device is responsible for instantaneous charge/discharge, and the high-energy first power storage device is responsible for long-term charge/discharge. This method has heretofore been proposed to improve the cycle life by reducing damage to the high-energy first power storage device caused by repeated charge/discharge.

An example of the conventional regenerative power supply system for electric railways includes such a configuration as illustrated in FIGS. 1 and 2 of Patent Literature 1 in which a storage cell (high-energy first power storage device) and an electric double layer capacitor (high-output second power storage device) are connected in parallel.

As shown in FIG. 5 of Patent Literature 1, the electric double layer capacitor is responsible for 100% of a charge current in the initial stage and the proportion of the storage cell is gradually increased, and the electric double layer capacitor is responsible also for 100% of a discharge current in the initial stage and the proportion of the storage cell is gradually increased.

In Patent Literature 1, the charge current flows to the regenerative power supply system when a brake is applied to a train and a motor functions as a generator to generate a regenerative current, and the discharge current flows from the regenerative power supply system when the train accelerates and the motor outputs large torque so that large electric power and a powering current are required.

Similarly, Patent Literature 2 describes the details of the configuration for railroad use in which a storage cell (high-energy first power storage device) and an electric double layer capacitor (high-output second power storage device) are connected in parallel, and a charge/discharge control method therefor. Paragraph [0035] of Patent Literature 2 describes (1B) the control after the end of regenerative operation, in which, after the end of regenerative operation, a booster chopper (DC/DC converter) is controlled to start discharge from the electric double layer capacitor to the storage cell.

Possible usage of this regenerative power supply system for railroad use is to stabilize feeding or prevent regeneration cancellation when mounted on a railroad car or installed as a ground facility.

Also for electric vehicles, a similar regenerative power supply system has heretofore been proposed. For example, FIG. 1 of Patent Literature 3 illustrates the configuration of a regenerative power supply system in which a high-energy battery and a high-output battery are connected in parallel via a 2-quadrant current chopper (DC/DC converter), which is for use in an electric vehicle or a hybrid electric vehicle whose power source is a DC power supply and an internal combustion engine.

FIG. 3 of Patent Literature 3 shows changes in current and voltage during deceleration. The high-energy battery (main battery) is responsible for a given level of the regenerative current, and the high-output battery (capacitor) is responsible for a regenerative current exceeding this level.

Similarly, FIG. 1 of Patent Literature 4 illustrates a regenerative power supply system for use in a vehicle or a hybrid vehicle. When a vehicle is estimated to move backward during a stop uphill or in other such situations, electric power charged in a capacitor is discharged to a secondary battery so as to prevent a decrease in backward suppressing torque, which is otherwise decreased if the capacitor is in a fully-charged state and a regenerative current for backward movement is therefore charged only in the secondary battery. In other words, this regenerative power supply system assumes the discharge from the capacitor to the secondary battery during a stop.

### CITATION LIST

### Patent Literature

[PTL 1] JP 2001-260718 A (FIGS. 1, 2, and 5)
[PTL 2] JP 2004-358984 A ([0035])
[PTL 3] JP 10-271611 A (FIGS. 1 and 3)
[PTL 4] JP 2008-30682 A (FIGS. 1 and [0005] to [0021])

### SUMMARY OF INVENTION

### Technical Problems

The conventional regenerative power supply systems in which the high-energy first power storage device and the high-output second power storage device are connected in parallel are configured as described above to perform the charge/discharge control. If a regenerative current flows and another regenerative current flows subsequently, the regeneration cannot be performed by the already-charged high-output second power storage device, and the high-energy first power storage device needs to be used for charge of a regenerative current. Thus, there has been a problem in that the life of the first power storage device cannot be extended.

Avoiding the reduction in life of the first power storage device has left another problem in that it is necessary to prepare a high-output second power storage device having a capacity sufficient for the high-energy first power storage device.

The present invention has been made in view of the above-mentioned problems, and it is an object thereof to provide a regenerative power supply system capable of extending the life of a high-energy first power storage device by using a high-output second power storage device that is as small a capacity as possible with respect to the first power storage device.

### Solution to Problems

A regenerative power supply system according to the present invention includes: a first power storage device of high energy type and a second power storage device of high output type, which are connected in parallel; a first ammeter and a first voltmeter for measuring a current and a voltage of the first power storage device, respectively; a second ammeter and a second voltmeter for measuring a current and a voltage of the second power storage device, respectively; a first DC/DC converter for controlling charge/discharge of the first power storage device; a second DC/DC converter for controlling charge/discharge of the second power storage device; and a control device for controlling the first DC/DC converter based on each output of the first ammeter and the first voltmeter and controlling the second DC/DC converter based on each output of the second ammeter and the second voltmeter, in which the control device includes charge/discharge control means including: a function of using the control device to control, with regard to reception of a regenerative current exceeding a current value I₀ set at a power migration start point, in an initial stage of regeneration (t=0), the first power storage device to be assigned with a regenerative current equal to or smaller than the current value I₀ set at the power migration start point and control the second power storage device to be assigned with the regenerative current exceeding the current value I₀ set at the power migration start point, and increasing a sharing current I₁(t) of the first power storage device to a maximum allowable current value of the first power storage device along a curve with a lapse of time; and a function of using the control device to perform discharge from the second power storage device to the first power storage device when the charge current I₁(t) of the first power storage device is equal to or smaller than the current value (I₀) set at the power migration start point in a period during which the regenerative current exceeding the current value set at the power migration start point is being charged in the first power storage device.

### Advantageous Effects of Invention

According to the regenerative power supply system of the present invention, the second power storage device is assigned only with the regenerative current exceeding the current value set at the power migration start point, and the sharing ratio of the first power storage device is increased with time along a sine curve so that the sharing ratio of the second power storage device becomes zero. Thus, there is an effect that the regenerative current can be increased in accordance with the controlled reaction rate of the first power storage device so that the damage to the first power storage device caused by the increased regenerative current can be suppressed as much as possible. There is another effect that wasted charge to the second power storage device can be prevented because the sharing ratio of the second power storage device is zero. If the charge current falls below the current value set at the power migration start point in the state where the first power storage device is being charged with a regenerative current exceeding the current value set at the power migration start point, the discharge from the second power storage device to the first power storage device is started. Thus, there is an effect that the electric power charged in the second power storage device can be migrated quickly to the first power storage device in a range in which the first power storage device is less damaged, and it is therefore possible to prepare for the next regeneration quickly.

### BRIEF DESCRIPTION OF DRAWINGS

FIG. 1 is a block diagram illustrating a configuration of a regenerative power supply system according to a first embodiment of the present invention (Example 1).

FIG. 2 is an explanatory diagram showing a charge/discharge operation of the regenerative power supply system according to the first embodiment of the present invention (Example 1).

FIG. 3 is an explanatory diagram showing sharing roles of first and second power storage devices of the regenerative power supply system according to the first embodiment of the present invention (Example 1).

FIG. 4 is an explanatory diagram showing a relationship between a threshold of a charge current to a lithium ion battery and the number of damages (Example 1).

FIG. 5 is a block diagram illustrating a configuration of a regenerative power supply system according to a second embodiment of the present invention (Example 2).

FIG. 6 is an explanatory diagram showing a charge/discharge operation of a regenerative power supply system according to a third embodiment of the present invention (Example 3).

FIG. 7 is a flowchart illustrating a charge/discharge control operation of the regenerative power supply system according to the third embodiment of the present invention (Example 3).

FIG. 8 is an explanatory diagram showing a set value of the ratio of a current value at a power migration start point to a maximum allowable current value of the first power storage device with respect to temperature of the first power storage device in the regenerative power supply system according to the third embodiment of the present invention (Example 3).

FIG. 9 is an explanatory diagram showing a set value of the ratio of the current value at the power migration start point to the maximum allowable current value of the first power storage device with respect to an SOC level of the first power storage device in the regenerative power supply system according to the third embodiment of the present invention (Example 3).

### DESCRIPTION OF EMBODIMENTS

Referring to the accompanying drawings, a regenerative power supply system according to exemplary embodiments of the present invention is described below.

### First Embodiment

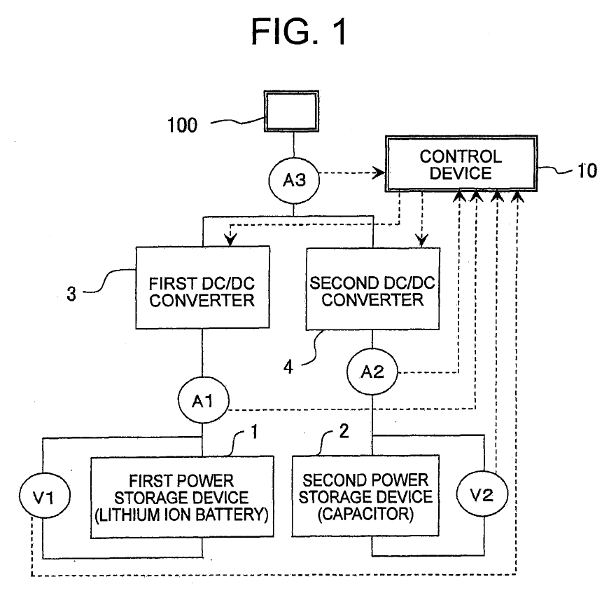

A regenerative power supply system according to a first embodiment of the present invention is now described with reference to FIGS. 1 to 4. FIG. 1 is a block diagram illustrating a configuration of the regenerative power supply system according to the first embodiment of the present invention. In the following, the same reference symbols in the drawings represent the same or corresponding components.

In FIG. 1, the regenerative power supply system according to the first embodiment of the present invention includes a lithium ion battery 1 as a high-energy first power storage device, an electric double layer capacitor 2 as a high-output second power storage device, a first ammeter A1 and a first voltmeter V1 for measuring a current and a voltage of the lithium ion battery 1, a second ammeter A2 and a second voltmeter V2 for measuring a current and a voltage of the electric double layer capacitor 2, a first DC/DC converter 3 for controlling charge/discharge of the lithium ion battery 1, a second DC/DC converter 4 for controlling charge/discharge of the electric double layer capacitor 2, and a control device 10 for controlling the first DC/DC converter 3 and the second DC/DC converter 5.

The lithium ion battery 1 and the electric double layer capacitor 2 are connected in parallel. The first DC/DC converter 3 and the second DC/DC converter 4 are also connected in parallel. The control device 10 controls the first DC/DC converter 3 and the second DC/DC converter 4 based on the current and the voltage of the lithium ion battery 1 measured by the first ammeter A1 and the first voltmeter V1 and the current and the voltage of the electric double layer capacitor 2 measured by the second ammeter A2 and the second voltmeter V2, respectively, to thereby control the charge/discharge of the lithium ion battery 1 and the electric double layer capacitor 2. An ammeter A3 for measuring an overall current is not always necessary, and a total value of the first ammeter A1 and the second ammeter A2 may be used.

A regeneration/powering operation source 100 is different depending on the application of the regenerative power supply system. For electric railways, for example, the regeneration/powering operation source 100 may be one for in-vehicle use designed for brake regeneration and one for ground use designed for feeding stabilization. For in-vehicle use, the regeneration/powering operation source 100 is an in-car power supply system connected to a motor, and, for ground use, the regeneration/powering operation source 100 is a power converter for connection to a feed line. For electric vehicles or hybrid vehicles, the regeneration/powering operation source 100 is an inverter for a motor. For general vehicles, the regeneration/powering operation source 100 corresponds to an inverter for an alternator directly connected to an engine. For idle-stop vehicles, the regeneration/powering operation source 100 corresponds to an inverter for a motor-generator. For solar power generation systems, the regeneration/powering operation source 100 corresponds to a DC/DC converter connected to a power supply of a solar panel. The first embodiment of the present invention is applicable to any of the applications.

Next, the regenerative power supply system according to the first embodiment of the present invention is described below with reference to the accompanying drawings.

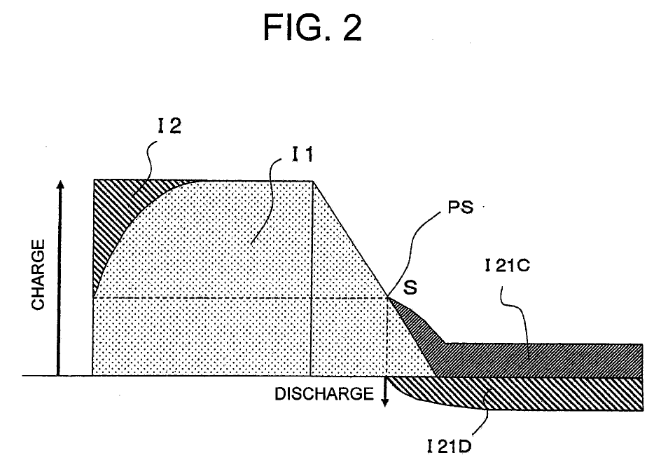

FIG. 2 is an explanatory diagram showing a charge/discharge operation of the regenerative power supply system according to the first embodiment of the present invention.

In FIG. 2, the horizontal axis represents time on a time scale of several seconds, though numerals are not shown. The vertical axis represents a charge current and a discharge current.

FIG. 2 shows a trapezoidal charge instruction from the regenerative/powering operation source 100 to the control device 10. FIG. 2 schematically shows a simplified waveform of the regenerative current for typical brake regeneration, which rises abruptly in the initial stage of charge and gradually decreases at the end of charge. A current value S indicates a power migration start point PS. When the current value exceeds this current value S, the control device 10 controls the first DC/DC converter 3 to start charging the lithium ion battery 1. A charge current I1 to the lithium ion battery 1 changes with time along a sine curve. Thus, the effect of avoiding charge at the rate exceeding the reaction rate of the lithium ion battery 1 can be obtained. This is because the reaction rate of the lithium ion battery 1 is controlled by the supply rate of a reactant and hence the current amount suitable for smooth reaction changes along a sine curve. The current value S set at the power migration start point PS is a maximum charge current value at which the lithium ion battery 1 is hardly damaged even when charged with this current directly.

The electric double layer capacitor 2 is assigned with the charge of a regenerative current exceeding the power migration start point PS. The sharing ratio of the electric double layer capacitor 2 is gradually decreased and becomes zero in the midpoint of the regenerative current. Accordingly, the waveform of a regenerative charge current I2 to the electric double layer capacitor 2 has a shape of a triangle ruler or a boomerang.

In many cases, depending on the application, the regenerative current shows a steep rise and has a tail as shown in FIG. 2, rather than becoming zero steeply.

In the first embodiment of the present invention, at the timing at which the charge current falls below the power migration start point PS, the control device 10 controls the first DC/DC converter 3 and the second DC/DC converter 4 to start charge I21C from the electric double layer capacitor 2 to the lithium ion battery 1, that is, discharge I21D from the electric double layer capacitor 2 to the lithium ion battery 1.

The charge current I21C from the electric double layer capacitor 2 to the lithium ion battery 1 and the discharge current I21D from the electric double layer capacitor 2 to the lithium ion battery 1 have basically the same value. The tail portion of the waveform at the end of charge has a shape like the mouth of a huge snake, which is the feature of the first embodiment of the present invention. This charge current is a current that hardly damages the lithium ion battery 1 when charging the lithium ion battery 1. The charge current I21C from the electric double layer capacitor 2 to the lithium ion battery 1 may be used to maintain the current value S set at the power migration start point PS, but, when the current is decreased, i²R losses, that is, the losses caused by the lithium ion battery 1, the electric double layer capacitor 2, the first DC/DC converter 3, the second DC/DC converter 4, wirings, and internal resistances thereof can be greatly reduced.

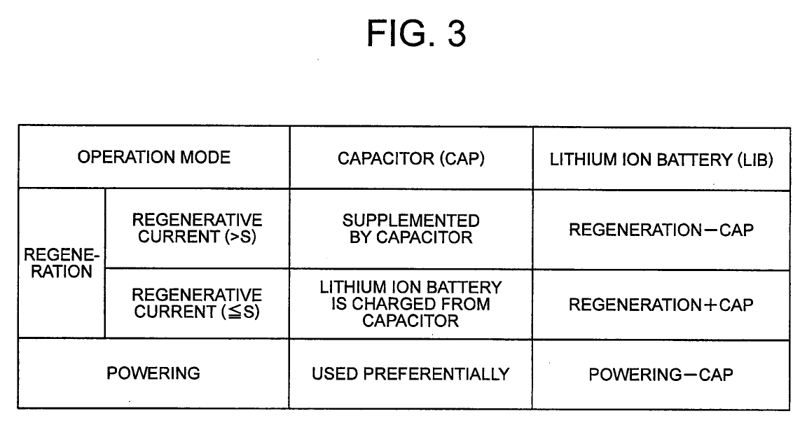

FIG. 3 is an explanatory diagram showing sharing roles of the first and second power storage devices of the regenerative power supply system according to the first embodiment of the present invention.

The table of FIG. 3 shows the sharing of the electric double layer capacitor 2 and the lithium ion battery 1 in each operation mode. A charge/discharge control algorithm of the control device 10 is designed based on the table. In the case where the operation mode is regeneration, the supplement (charge) of the electric double layer capacitor 2 is not performed in a range where the regenerative current falls below the current value S set at the power migration start point PS. When the regenerative current exceeds the current value S set at the power migration start point PS, the supplement (charge) of the electric double layer capacitor 2 is started. In this case, the supplement ratio of the electric double layer capacitor 2 is set so that a charge curve of the lithium ion battery 1 may change substantially along a sine curve. The electric double layer capacitor 2 is increased in cell voltage as the state of charge becomes higher. Therefore, simply by controlling the current value of the electric double layer capacitor 2 to be constant, the charge curve of the lithium ion battery 1 changes substantially along a sine curve.

After that, when the regenerative current falls below the current value S set at the power migration start point PS, the electric power stored in the electric double layer capacitor 2 starts to migrate to the lithium ion battery 1, in other words, power migration starts. In this period, the charge current to the lithium ion battery 1 is a value obtained by adding the charge current from the electric double layer capacitor 2 to the regenerative current (regeneration+CAP).

In the case where the operation mode is powering, the current is generated when torque is necessary for rotating the motor. The current is preferentially discharged from the electric double layer capacitor 2, and is discharged from the lithium ion battery 1 to compensate for the shortage.

Specifically, the control device 10 controls the first DC/DC converter 3 and the second DC/DC converter 4 so that, with regard to the reception ratio of the regenerative current, the electric double layer capacitor 2 (second power storage device) is assigned with a regenerative current exceeding the current value S set at the power migration start point PS in the initial stage of regeneration, and the sharing ratio of the lithium ion battery 1 (first power storage device) is increased along a sine curve with a lapse of time so that the sharing ratio of the electric double layer capacitor 2 becomes zero. Then, if the charge current is equal to or smaller than the current value S set at the power migration start point PS in a period during which the regenerative current exceeding the current value S set at the power migration start point is being charged in the lithium ion battery 1, the discharge from the electric double layer capacitor 2 to the lithium ion battery 1 is started.

The series of the charge/discharge control by the control device 10 described above allows even an electric double layer capacitor 2 having a small capacity to discharge electric power immediately to maintain an empty state without continuing a fully-charged state. It is therefore possible to deal with a successive regenerative current and alleviate the damage to the lithium ion battery 1. Particularly at the start of charge, the electric double layer capacitor 2 is not assigned with a regenerative current more than necessary, and the electric double layer capacitor 2 supplements a regenerative current to the minimum extent necessary so that the charge reaction of the lithium ion battery 1 shows an ideal curve. Thus, the damage to the lithium ion battery 1 can be reduced effectively with a small supplement of charge.

Now, a charge/discharge simulation test is described below. The lithium ion battery 1 formed of 30 cells of 50-Ah lithium ion batteries connected in series and the electric double layer capacitor 2 formed of 20 cells of 1,000-F electric double layer capacitors connected in series were connected in parallel via the first and second DC/DC converters 3 and 4, respectively. A total voltage and a total energy amount of the lithium ion battery 1 were about 100 V and about 5.6 kWh, respectively, and a maximum rated voltage and a total energy amount of the electric double layer capacitor 2 were 50 V and about 17 Wh, respectively. The total energy amount of the electric double layer capacitor 2 is only 0.3% of that of the lithium ion battery 1. In terms of cost, this system can be built with only a small increase in cost. A maximum charge current allowance of the lithium ion battery 1 was 100 A.

A JC08 mode pattern, which is a representative vehicle running mode, was input to the control device 10, and a charge/discharge simulation test was performed to examine a change in current and voltage with time. This simulation test was conducted with six kinds of the current value S set at the power migration start point PS, 50 A, 40 A, 30 A, 20 A, 10 A, and 0 A. The change in current and voltage with time was also examined for a comparative example in which the electric double layer capacitor 2 was not connected in parallel but the lithium ion battery 1 was used alone.

It is difficult to determine the degradation of the lithium ion battery 1 in a short period of time, and hence the following number of damages is used. Specifically, the number of damages Y of the lithium ion battery 1 was calculated based on Expression (1) below by using actually-measured charge/discharge current and voltage values of the lithium ion battery 1 and the electric double layer capacitor 2.

Y=SOCE*I/B (1)

where I represents a maximum charge current [A] during charge of the lithium ion battery 1, and B represents an allowable maximum current [A] of the lithium ion battery 1.

In Expression (1), SOCE (state of charge end) is a state of charge (SOC) [%] at the end of charge of the lithium ion battery 1. For example, in the case where the lithium ion battery 1 is charged from SOC50% to SOC70%, the SOCE is used as 70 in the calculation of Expression (1). The SOC of the lithium ion battery 1 can be calculated based on a cell voltage or a total voltage of the lithium ion battery 1, but may be calculated based on an integrated value of the charge/discharge current of the lithium ion battery 1.

Further, in the case of the simulation test, the allowable maximum current [A] is 100 A. Therefore, the number of damages can be calculated based on the maximum charge current value I measured upon the completion of the charge of the lithium ion battery 1.

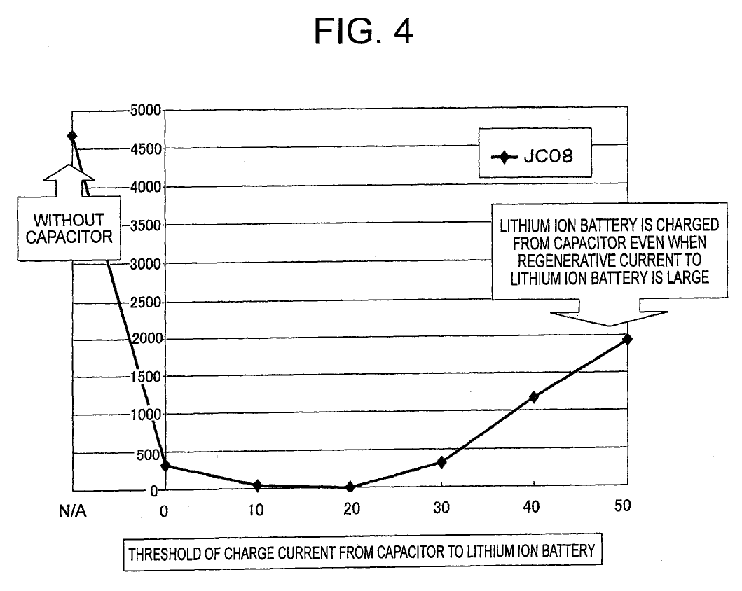

The number of damages Y was integrated for a single JC08 mode. A series of the result is shown in FIG. 4. FIG. 4 is an explanatory diagram showing the relationship between the threshold of the charge current to the lithium ion battery and the number of damages. In FIG. 4, the horizontal axis represents the current value S [A] set at the power migration start point PS, and the vertical axis represents an integrated value of the number of damages Y. The left end of the graph shows a comparative example in which the lithium ion battery was not connected in parallel to the electric double layer capacitor 2.

It was found that the number of damages Y exceeded 4,500 in the case where the lithium ion battery was not connected in parallel to the electric double layer capacitor 2, and the lithium ion battery 1 was more damaged by the charge in the JC08 mode. On the other hand, in the case where the lithium ion battery was connected in parallel to the electric double layer capacitor 2, the number of damages Y was significantly reduced irrespective of the current value S [A] set at the power migration start point PS. This simulation test has demonstrated the effects of the first embodiment of the present invention.

What is worth is that the number of damages Y is maintained to be substantially zero when the current value S [A] at the power migration start point PS is set to be 10 A to 20 A (10% to 20% of the maximum allowable current value). It was revealed that the effects of the first embodiment of the present invention were particularly high in this region. When the current value S [A] exceeded 50 A greatly, the number of damages Y was also increased greatly. It is therefore desired that the current value S [A] at the power migration start point PS be set in the range of from 10% to 50% of the maximum allowable current value.

The simulation test was programmed so that the discharge from the electric double layer capacitor 2 to the lithium ion battery 1 was performed so that electric power migrated with about 5 A (5% of the maximum allowable current value) when the regenerative current fell below the current value S [A] set at the power migration start point PS. The proportion to the maximum allowable current value is desirably 1% or more and 10% or less. When the proportion fell below 1%, discharge took too much time to be completed before the next regeneration, which lowered the effect of reducing the number of damages Y. On the other hand, when the proportion exceeded 10%, a large loss by the internal resistance occurred during power migration between the electric double layer capacitor 2 and the lithium ion battery 1 including the first and second DC/DC converters 3 and 4, which deteriorated the regeneration efficiency.

Further, in the simulation test, the maximum storage amount of the electric double layer capacitor 2 was 0.3% of that of the lithium ion battery 1. The maximum storage amount is desirably in the range of from 0.1% to 1%. When the maximum storage amount falls below 0.1%, the internal resistance of the electric double layer capacitor 2 is increased to deteriorate the regeneration efficiency. On the other hand, when the maximum storage amount exceeds 1%, the cost and the volume are increased to reduce the added value as a system.

### Second Embodiment

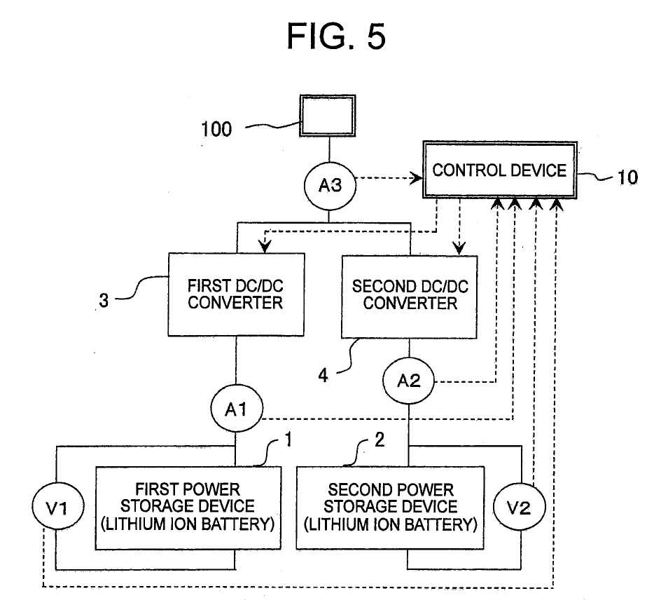

Referring to FIG. 5, a regenerative power supply system according to a second embodiment of the present invention is described below. FIG. 5 is an explanatory diagram illustrating a configuration of the regenerative power supply system according to the second embodiment of the present invention.

In FIG. 5, the second embodiment is different from the above-mentioned first embodiment in that a high-energy lithium ion battery 1 is used as a high-energy first power storage device and a high-output lithium ion battery 2 is used as a high-output second power storage device, and those batteries are connected in parallel.

The high-energy lithium ion battery 1 may be a large-sized lithium battery for electric vehicle use as used in the first embodiment. The high-energy lithium ion battery 1 may be a large-sized lithium battery for hybrid vehicle use or industrial use.

In the case where the high-output lithium ion battery 2 is used as the second power storage device, the voltage variable range is limited, and the internal resistance becomes larger than that of the electric double layer capacitor. It is therefore desired that a maximum storage amount of the high-output lithium ion battery 2 be 1% or more and 10% or less of that of the high-energy lithium ion battery 1. If the maximum storage amount of the high-output lithium ion battery 2 exceeds 1%, a larger loss occurs in charge/discharge due to the internal resistance, and the regeneration efficiency is deteriorated. On the other hand, if the maximum storage amount of the high-output lithium ion battery 2 exceeds 10%, the volume and the weight are increased much to reduce the added value as a system.

Even when the high-output lithium ion battery 2 is used instead of the electric double layer capacitor, the damage to the high-energy lithium ion battery 1 can be reduced similarly. In this case, however, the damage to the high-output lithium ion battery 2 may be increased, but the maximum storage amount of the high-output lithium ion battery 2 is 1% or more and 10% or less of that of the high-energy lithium ion battery 1, and hence the effect that the high-output lithium ion battery 2 can be replaced at less cost can be obtained.

While the case where the lithium ion battery is used has been described above, the same effects can be obtained even when a nickel hydride battery or a lead acid battery is used.

While the above-mentioned second embodiment of the present invention assumes a vehicle, it should be understood that the same effects can be expected even in other applications including electric railway use and leveling in solar power generation.

### Third Embodiment

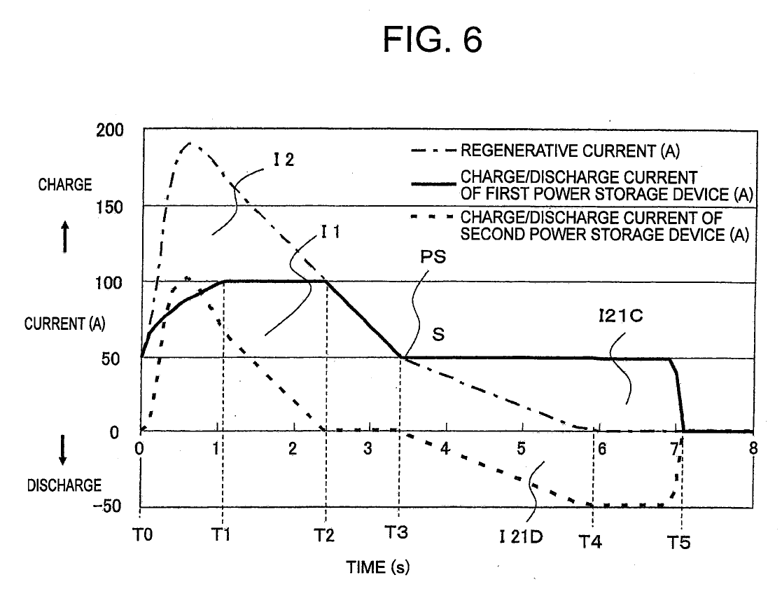

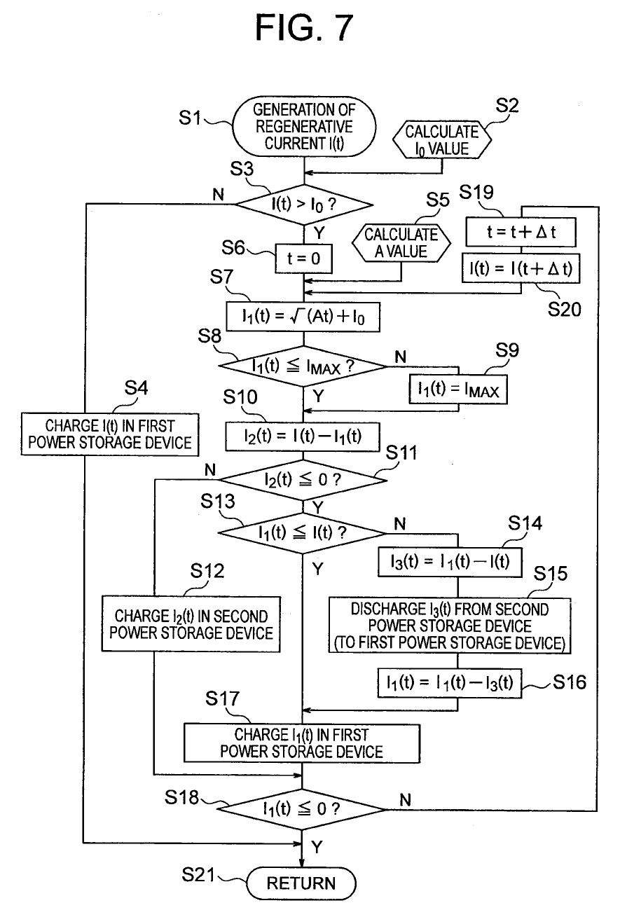

Referring to FIG. 6 and a flowchart of FIG. 7, charge/discharge control of a regenerative power supply system according to a third embodiment of the present invention is described below.

In the third embodiment of the present invention illustrated in FIGS. 6 and 7, similarly to the above-mentioned second embodiment, a high-energy lithium ion battery is used as a high-energy first power storage device, and a high-output lithium ion battery is used as a high-output second power storage device. A maximum storage amount of the high-output lithium ion battery 2 is 5% of that of the high-energy lithium ion battery.

In FIG. 6, the chain line represents a time change in regenerative current, the solid line represents a time change in charge/discharge current of the first power storage device, and the broken line represents a time change in charge/discharge current of the second power storage device. In FIG. 6, the regenerative current and the charge current have positive values. In FIG. 6, unlike the case of FIG. 2, the regenerative current from the motor has a steep mountain shape on the left side. FIG. 2 corresponds to a motor when a relatively weak brake is applied, and FIG. 6 corresponds to a motor when a sudden brake is applied. Depending on the application, such a charge current as shown in FIG. 6 may be generated instead of a charge current accompanying a pre-established controlled brake shown in FIG. 2.

The electric double layer capacitor is used in FIG. 2, but, as understood from FIG. 6, even when the high-output lithium ion battery is used, the same effects as those in FIG. 2 can be obtained to reduce the damage to the high-energy first power storage device.

Now, the charge/discharge current shown in FIG. 6 is described below for each different elapsed time, a time T0 to a time T5.

At the time T0, the control device 10 detects the generation of a regenerative current based on a motor brake control signal or the like, and calculates an expected regenerative current. When the value of the expected regenerative current does not exceed a current value I₀ (=50 A) set at the power migration start point, only the first power storage device is charged. When the value of the expected regenerative current exceeds the current value I₀ set at the power migration start point, this detection timing is set in an initial stage of regeneration (t=0), and the sharing of the regenerative current between the first power storage device and the second power storage device is started.

Between the time T0 to the time T1, a sharing current (charge current) to the first power storage device gradually increases along a curve. This can prevent an adverse effect caused by an abrupt charge of the first power storage device. The remaining regenerative current is assigned to the second power storage device, and is charged in the second power storage device.

Between the time T1 to the time T2, the sharing current (charge current) to the first power storage device reaches a maximum allowable current value I_{MAX} (=100 A) of the first power storage device, and hence the sharing current (charge current) to the first power storage device is fixed to the value of the maximum allowable current value I_{MAX}.

Between the time T2 to the time T3, the regenerative current decreases to fall below the maximum allowable current value I_{MAX} (=100 A) of the first power storage device, and hence the regenerative current is all charged in the first power storage device.

Between the time T3 to the time T4, the regenerative current decreases to fall below the current value I₀ (=50 A) set at the power migration start point, and hence the regenerative power stored in the second power storage device is discharged to the first power storage device, and the charge to the first power storage device is continued in the state where the regenerative current is maintained to be the current value I₀ (=50 A) set at the power migration start point. The first power storage device is charged by a constant current of the current value I₀ (=50 A) set at the power migration start point, and hence the first power storage device is less damaged.

At the time T4, the regenerative power converges. The conventional control device starts the operation of discharging the regenerative power stored in the second power storage device to the first power storage device at this timing. In the third embodiment of the present invention, however, most of the regenerative power stored in the second power storage device has been already discharged to the first power storage device at this timing.

The period between the time T4 and the time T5 is a period for discharging the regenerative power stored in the second power storage device to the first power storage device. At the timing of T5, all of the regenerative power stored in the second power storage device has been discharged, and it is ready to receive the next regenerative power. In the case where a brake pedal is depressed several times separately, the regenerative current as shown in FIG. 6 is repeatedly generated. According to the regenerative power supply system of the third embodiment of the present invention, the regenerative power stored in the second power storage device is quickly discharged to the first power storage device, and hence the regenerative power can be charged effectively by the second power storage device having a smaller capacity than a conventional one.

By using the means for gradually increasing the sharing current to the first power storage device along a curve, which is calculated and controlled by the control device 10 of the regenerative power supply system according to the third embodiment of the present invention, an adverse effect caused by an abrupt charge of the first power storage device can be prevented.

Referring to a flowchart of FIG. 7, the charge/discharge control of the control device 10 is described in more detail below. For simple description, a current value based on a regenerative current value is shared between the first power storage device and the second power storage device. To be precise, after the current value is shared between the first power storage device and the second power storage device, the current value of each power storage device is calculated and determined by the control device 10 in consideration of the voltages of the first power storage device and the second power storage device and the resistance losses thereof. For easy discrimination between charge and discharge, the current values in the description are all expressed as positive values.

First, In Step S1, the control device 10 detects the generation of a regenerative current based on a motor brake control signal or the like, and calculates an expected regenerative current I(t).

In Step S2, a current value I₀ at a power migration start point is determined based on a state of charge (SOC) and temperature of the first power storage device.

Subsequently, in Step S3, it is determined whether or not the relationship “I(t)>I₀” is satisfied.

When the determination result of Step S3 is “I(t)≦I₀” (that is, NO), in Step S4, the regenerative current I(t) is all charged in the first power storage device, and the processing proceeds to Step S21 for returning (finishes the charge/discharge operation for regeneration).

However, when the SOC of the first power storage device is too high and the charge cannot be performed, the processing skips Step S4 and cancels the execution of regeneration (the illustration is omitted in FIG. 7 for simplification).

In Step S5, the value of a constant A is determined based on the SOC and temperature of the first power storage device. In this case, the value of the constant A is 2,400. When the value of the constant A is set to be larger, a steep rise occurs along a curve. In contrast, when the value of the constant A is set to be smaller, a gentle rise occurs along a curve.

On the other hand, when the determination result of Step S3 is “I(t)>I_{D}” (that is, YES), in Step S6, the regenerative initial time (t=0) is set.

Subsequently, in Step S7, the value to be obtained by increasing the sharing current I₁(t) of the first power storage device along a curve at the time t is calculated based on Expression (2) below by using the current value I₀ set at the power migration start point and the constant A.

I₁(t)=√(At)+I₀ (2)

In Step S8, it is determined whether or not the sharing current I₁(t) of the first power storage device obtained by the calculation of Expression (2) is equal to or smaller than a maximum allowable current value I_{MAX} of the first power storage device (I₁(t)≦I_{MAX})

When the determination result of Step S8 is “I₁(t)>I_{MAX}” (that is, NO), in Step S9, the sharing current I₁(t) of the first power storage device is replaced with the maximum allowable current value I of the first power storage device (I₁(t)=I_{MAX}), and the processing proceeds to Step S10.

On the other hand, when the determination result of Step S8 is “I₁(t)≦I_{MAX}” (that is, YES), in Step S10, a value (I(t)−I₁(t)) obtained by subtracting the sharing current I₁(t) of the first power storage device from the regenerative current I₁(t) is calculated as a sharing current I₂(t) of the second power storage device.

Subsequently, in Step S11, it is determined whether or not the sharing current I₂(t) of the second power storage device is equal to or smaller than 0 (I₂(t)≦0).

When the determination result of Step S11 is “I₂(t)>0” (that is, NO), in Step S12, the sharing current I₂(t) is assigned to the second power storage device, and the processing proceeds to Step S18 for determination to be described later.

On the other hand, when the determination result of Step S11 is “I₂(t)≦0” (that is, YES), in Step S13, it is determined whether or not the sharing current I₁(t) of the first power storage device is equal to or smaller than the regenerative current I(t), and it is confirmed that “I₁(t)≦I(t)” is satisfied. In some cases, the regenerative current I(t) becomes smaller than the sharing current I1(t) along with the time t (with a lapse of time).

When the determination result of Step S13 is “I₁(t)>I(t)” (that is, NO), the regenerative current I(t) has become smaller than the sharing current I₁(t) of the first power storage device, and hence there is an additional charge margin in the sharing current I₁(t) of the first power storage device. In Step S14, the margin is calculated as I₃(t).

Subsequently, in Step S15, the control device 10 controls the DC/DC converter for the second power storage device so that the first power storage device is charged from the second power storage device by the additional charge margin I₃(t) generated in the sharing current I₁(t) of the first power storage device.

Subsequently, in Step S16, a current value (I₁(t)+I₃(t)) obtained by subtracting the margin I₃(t) from the sharing current I₁(t) of the first power storage device is set as a new sharing current I₁(t) of the first power storage device, and the processing proceeds to Step S17.

On the other hand, when the determination result of Step S13 is “I₁(t)≦I(t)” (that is, YES), in Step S17, the sharing current I₁(t) is charged in the first power storage device.

Subsequently, in Step S18, it is determined whether or not the sharing current I₁(t) to be charged in the first power storage device is equal to or smaller than 0 (I₁(t)≦0).

When the determination result of Step S18 is “I₁(t)>0” (that is, NO), it is regarded that there is still electric power to be regenerated, and hence in Step S19, the time t is updated and set to a value (t+Δt) incremented by the elapsed time Δt.

Subsequently, in Step S20, the regenerative current I(t) is also updated and set to a value (I(t)+Δt) at a time (t+Δt) incremented by the elapsed time Δt, which is fetched as new data. Then, the processing proceeds to Step S7.

After that, the charge/discharge control process of Steps S7 to S18 is repeatedly executed. Finally, when the determination result of Step S18 is “I₁(t)≦0” (that is, YES), the processing of the regenerative current is regarded as completed, and in Step S21, the charge/discharge operation for regeneration is finished.

The sequence illustrated in the flowchart of FIG. 7 is stored in a microcomputer mounted on the circuit board of the control device 10 or the like. The control device 10 is equipped also with a memory, and arithmetic processing data necessary for the flowchart of FIG. 7 is stored in the memory.

The elapsed time Δt is different depending on response time of the DC/DC converter or the performance of the microcomputer. For example, even when the elapsed time Δt is set to be about 0.1 seconds to provide a relatively long control interval, the above-mentioned effects can be obtained sufficiently.

In the above-mentioned third embodiment, the regenerative current [A] is distributed. Alternatively, however, regenerative power [W] may be distributed by a charge/discharge control similarly to that of the flowchart of FIG. 7. In any case, the same effects can be obtained.

In an actual case where the regenerative current [A] or the regenerative power [W] is distributed between the first power storage device and the second power storage device, it is necessary to take into account the loss caused by the respective voltages and internal resistances and the loss caused by energy conversion of the DC/DC converter. In this case, the value of the regenerative current [A] or the regenerative power [W] is shared by being replaced with the actual current and voltage of the first power storage device and the actual current and voltage of the second power storage device (the illustration is omitted in FIG. 7 for simplification).

In the above-mentioned third embodiment, the maximum allowable current value I_{MAX} (=100 A) of the first power storage device, the current value I₀ (=50 A) at the power migration start point, and the constant A (=2,400) are fixed values. Alternatively, however, the value of the ratio [%] of the current value I0 at the power migration start point to the maximum allowable current value I_{MAX} of the first power storage device and the value of the constant A may be variably set. This can greatly enhance the above-mentioned effects.

A description is now given of a modified example of the ratio of the current value I₀ at the power migration start point to the maximum allowable current value of the first power storage device.

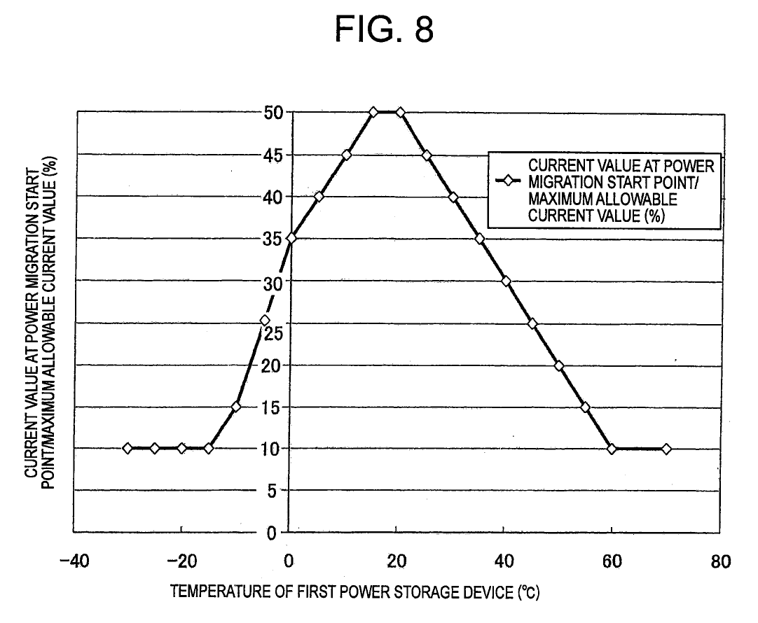

FIG. 8 is an explanatory diagram showing a set value of the ratio of the current value at the power migration start point to the maximum allowable current value of the first power storage device with respect to the temperature of the first power storage device.

In FIG. 8, the ratio of the current value at the power migration start point to the maximum allowable current value of the first power storage device is set to be smaller as the temperature becomes higher than 20° C. and to be smaller as the temperature becomes lower than 20° C.

This increases the sharing ratio of the high-output lithium ion battery in a high temperature region and a region lower than zero degrees where the damage to the high-energy first power storage device is large. Thus, the damage to the energy-type first power storage device can be reduced more effectively.

Also the second power storage device is more likely to have the same temperature as that of the first power storage device. Thus, if the set value of the ratio of the current value at the power migration start point to the maximum allowable current value of the first power storage device is set to be more than 50%, the damage to the high-output lithium ion battery 2 is increased adversely.

It is therefore desired that the set value of the ratio of the current value at the power migration start point to the maximum allowable current value of the first power storage device be 10% or more and less than 50%.

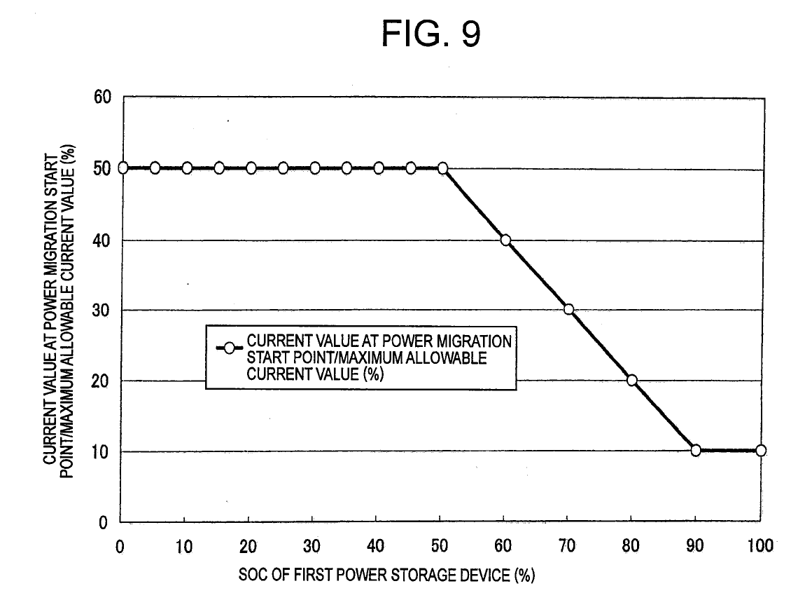

FIG. 9 is an explanatory diagram showing a set value of the ratio of the current value at the power migration start point to the maximum allowable current value of the first power storage device with respect to the SOC level of the first power storage device.

The ratio of the current value at the power migration start point to the maximum allowable current value of the first power storage device is set to be smaller as the SOC level of the first power storage device becomes higher.

This increases the sharing ratio of the high-output lithium ion battery in a region where the SOC level of the first power storage device is high and the damage to the high-energy first power storage device is large. Thus, the damage to the energy-type first power storage device can be reduced more effectively.

When the first power storage device is in the region in which the SOC level is high, the second power storage device is also likely to be in a region in which the SOC level is relatively high. Thus, if the set value of the ratio of the current value at the power migration start point to the maximum allowable current value of the first power storage device is set to be more than 50%, the damage to the high-output lithium ion battery is increased adversely.

It is therefore desired that the set value of the ratio of the current value at the power migration start point to the maximum allowable current value of the first power storage device be 10% or more and less than 50%.

An appropriate set value of the constant A is greatly different depending on the specifications of the first power storage device to be used. When the value of the constant A is large, the charge current abruptly increases. When the value of the constant A is small, the charge current gradually increases. Thus, by setting the value of the constant A to be smaller as the temperature becomes higher than 20° C. and to be smaller as the temperature becomes lower than 20° C., it becomes possible to build a regenerative power supply system in which the damage to the first power storage device is effectively reduced at a high temperature and a low temperature (particularly, low temperature of 0° C. or lower) where the durability of the first power storage device is poor.

By setting the value of the constant A to be smaller as the SOC level of the first power storage device becomes higher, it becomes possible to build a regenerative power supply system in which the damage to the first power storage device is effectively reduced at a high SOC level where the durability of the first power storage device is poor.

Alternatively, the value of the constant A may be variable depending on the degradation degree of the first power storage device. By setting the value of the constant A to be large in the initial stage where degradation is small and to be smaller as closer to the end stage where degradation has progressed depending on the degradation degree of the first power storage device stored in the control device 10, it becomes possible to reduce the damage effectively depending on the degradation degree of the first power storage device. The degradation degree of the first power storage device can be determined based on an increase in internal resistance of the first power storage device. Alternatively, the degradation degree may be determined based simply on a cumulative time of charge/discharge using the first power storage device. In this case, the arithmetic operation of the microcomputer of the control device 10 can be more simplified.

While the description of the above-mentioned first to third embodiments assumes motor regeneration, the regenerative power supply system of the present invention can be used for output leveling in solar power generation, for example.

In the case of solar power generation, an abrupt increase in output occurs when the sun comes out of the clouds, and if the output is reversed to a system as it is, the system voltage may increase abnormally. Leveling is therefore desired by storing electricity with the use of the regenerative power supply system of the present invention.

For example, the phenomenon that the output abruptly increases when the sun comes out of the clouds is similar to the above-mentioned third embodiment exemplifying sudden braking. When the clouds are sparse such as cirrocumulus clouds, this phenomenon is repeated in a short period of time, and hence the effects of the present invention can be obtained more remarkably. In this case, the term “regeneration” is not used in the field of output leveling in solar power generation, but means the charge of a power storage device for output leveling in solar power generation.

### REFERENCE SIGNS LIST

1 lithium ion battery, 2 electric double layer capacitor, 3 first DC/DC converter, 4 second DC/DC converter, 10 control device, 100 regeneration/powering operation source, A1 first ammeter, A2 second ammeter, A3 ammeter, V1 first voltmeter, V2 second voltmeter.

1. A regenerative power supply system, comprising:
a first power storage device of high energy type and a second power storage device of high output type, which are connected in parallel;
a first ammeter and a first voltmeter for measuring a current and a voltage of the first power storage device, respectively;
a second ammeter and a second voltmeter for measuring a current and a voltage of the second power storage device, respectively;
a first DC/DC converter for controlling charge/discharge of the first power storage device;
a second DC/DC converter for controlling charge/discharge of the second power storage device; and
a control device for controlling the first DC/DC converter based on each output of the first ammeter and the first voltmeter and controlling the second DC/DC converter based on each output of the second ammeter and the second voltmeter,
wherein the control device comprises charge/discharge control means including:
a function of using the control device to control, with regard to reception of a regenerative current exceeding a current value I₀ set at a power migration start point, in an initial stage of regeneration (t=0), the first power storage device to be assigned with a regenerative current equal to or smaller than the current value I₀ set at the power migration start point and control the second power storage device to be assigned with the regenerative current exceeding the current value I₀ set at the power migration start point, and increasing a sharing current I₁(t) of the first power storage device to a maximum allowable current value of the first power storage device along a curve with a lapse of time; and
a function of using the control device to perform discharge from the second power storage device to the first power storage device when the charge current I₁(t) of the first power storage device is equal to or smaller than the current value I₀ set at the power migration start point in a period during which the regenerative current exceeding the current value set at the power migration start point is being charged in the first power storage device.

2. A regenerative power supply system according to claim 1, wherein the sharing current I₁(t) of the first power storage device is calculated based on the following expression:
I₁(t)=√(At)+I₀
where A represents a constant.

3. A regenerative power supply system according to claim 1, wherein the current value I₀ set at the power migration start point is 10% or more and less than 50% of the maximum allowable current value of the first power storage device.

4. A regenerative power supply system according to claim 1, wherein the current value I₀ at the power migration start point is set to be smaller as temperature becomes higher than 20° C. and to be smaller as the temperature becomes lower than 20° C.

5. A regenerative power supply system according to claim 1, wherein the current value I₀ at the power migration start point is set to be smaller as an SOC level of the first power storage device becomes higher.

6. A regenerative power supply system according to claim 2, wherein a value of the constant A is set to be smaller as temperature becomes higher than 20° C. and to be smaller as the temperature becomes lower than 20° C.

7. A regenerative power supply system according to claim 2, wherein a value of the constant A is set to be smaller as an SOC level of the first power storage device becomes higher.
